(19) United States
(12) Patent Application Publication
(10) Pub. No.: US 2004/0029008 A1
(43) Pub. Date: Feb. 12, 2004

(54) Method for producing rechargeable lithium-polymer batteries and a battery produced according to said method

(76) Inventors: Franz W. Winterberg, Ilfeld (DE); Reiner Zimmermann, Nordhausen (DE); Kerstin Siury, Nordhausen (DE)

Correspondence Address: Jordan & Hamburg, 122 East 42nd Street, New York, NY, 10168, US

(21) Appl. No.: 10/297,074

(22) PCT Filed: Apr. 20, 2001
(86) PCT No.: PCT/EP01/04540

(30) Foreign Application Priority Data
Apr. 22, 2000 (DE) 100 20 031.1

(51) Int. Cl. H01M 4/58; H01M 10/40

(52) U.S. Cl. 429/231.1; 429/303; 429/316; 429/314; 429/317

(57) ABSTRACT

The invention relates to a rechargeable lithium-polymer battery, characterized by the following construction: a collector film (8, 9); a cathode active substance (15) which contains a transition metal oxide capable of intercalation as the active component, a conducting additive and a polymer which has been swelled in a supporting electrolyte solution; a polymer-gel electrolyte (13) consisting of polymers that have been swelled in a supporting electrolyte solution; an anode active substance (11) which contains a material capable of intercalation as the active component and a polymer that has been swelled in a supporting electrolyte solution; and a collector film (8, 9).

### DESCRIPTION

The invention relates to a procedure to supply a rechargeable lithium polymer battery as well as to the battery itself, which consist of a composite anode, an polymer gel electrolyte and a composite cathode, the active intercalation anode material is graphite, the active intercalation cathode material is a lithium transition metal oxide. This battery is of large interest due to its electrochemical properties, its high energy density and its improved safety compared with batteries having Li-metal as anode.

A rechargeable lithium battery basically consists of two intercalation electrodes, and the lithium ion “shuttles” between these electrodes. For the cathode usually LiCoO₂, LiNiO₂ or LiMn₂O₄ are applied. For the anode often intercalation graphite is used. The electrolyte consist of aprotic organic solvents like ethylene carbonate (EC), propylene carbonate (PC), dimethyl carbonate (DMC) or Diethyl carbonate (DEC) and of a electrolyte salt like LiClO₄, LiPF₆ or LiCF₃SO₃.

Conventional methods use process solvents to deposit layers of the electrode substances onto the current collector foils. After the removal of the process solvent the coated collector foils are winded (a separator layer separating the electrodes) to form the battery. The separator layer consists for example of porous polyethylene or polypropylene, the pores will be filled with electrolyte salt solution to enable the ionic contact between the electrodes.

Alternatively it is known that it is possible to achieve solid polymer electrolytes, for example from polyethylene oxide and an electrolyte salt. The solid polymer electrolytes have the disadvantage of poor conductivity at room temperature. Above 60° C. acceptable conductivities are achieved. To achieve an acceptable temperature performance it is required to modify the polymer electrolyte, for example by use of plastizising solvents like EC, PC, DEC or DMC.

Also known is the application of a Poly[vinylidene difluoride-hexafluoropropylene] (PVDF-HFP-copolymer) as polymer matrix in polymer-gel-electrolytes (Feullade and Perch, J. Appl. Electrochem. 5, 63069, 1997) for the Li/CuS system. A disadvantage of the described method is that the polymer matrix for the electrodes and the electrolyte has to be prepared by use of process solvents. After the removal of the process solvent the NH₄ClO₄ in PC solution is soaked into the polymer matrix.

The patents of Bell Communication Research, Inc. (U.S. Pat. No. 5,192,629, U.S. Pat. No. 5,296,318, U.S. Pat. No. 5,456,000) further developed and modified this principle for a 4 V system C/electrolyte/LiMn₂O₄ resulting in the so-called PLion™ battery. Also this procedure bases on process solvents to coat, and after the removal of the process solvent the electrolyte salt solution soaks into the polymer.

The patent DE 34 85 832 T2 (Cook et al.), (corresponding to EP 0 145 498 B1 and U.S. Pat. No. 4,818,643) relates to a method to prepare polymer gel electrolytes and cathodes without process solvent. Both substances are extruded as foils using a nozzle. The disadvantage of the described method is the application of polyethylene oxide. Polyethylene oxide is mechanically not robust, and several preparation steps are required to achieve the gel-electrolyte, involving the use of electrolyte salt solution as plastizisers.

In U.S. Pat. No. 5,725,822 the continuous preparations of electrode substances is described. This patent, however deals with polymer electrolyte systems where the polymer matrix consists of pure polymers like polyacrylnitrile (PAN), polyvinylidenflouride (PVDF) or polyvinylepyrrolidene (PVP).

Methods to prepare polymer electrolytes and to coat it onto pre-prepared anodes are described in the patents U.S. Pat. Nos. 5,348,824 and 5,593,462. The patents does not refer to a polymer gel electrolyte but to classical polymer electrolytes, which contain an electrolyte salt but no plasticizer.

The patent JP 10,172,573 describes a method to prepare an intercalation graphite anode. As binder a mixture of polymers consisting of polyvinylidenflouride (PVDF) and polymethacrylate (PMMA). The polymer matrix acts as the binder in the negative electrode which later is soaked by a liquid aprotic electrolyte—thus the patent refers not to a lithium polymer battery but to a conventional lithium iron battery with liquid electrolyte.

Conventional art describes methods, which apply process solvents, and after preparation of the active layer or films the process solvent is removed. The winded battery is kept inactive. To active it, it is soaked with electrolyte solution and the cavities originating from the expulsion of the process solvent are refilled with liquid electrolyte. After that the battery is ready for use.

The objective of the actual invention is to avoid the disadvantages of the conventional methods. This is achieved by a complete avoidance of process solvents and by applying a polymer, which is able to gel in the electrolyte salt solution. The actual invention furthermore discloses to prepare a lithium polymer battery where gelled polymer is present in all components. In this way the battery is ready for use and later activation by soaking with electrolyte, as required in conventional art, is not required.

The invention relates to a solvent free process to supply rechargeable lithium polymer batteries, the process being characterized by a separate preparation of

a cathode substance, which contains as components

an active cathode materials being a transitional metal oxide able to intercalate lithium,

an electrolyte salt solution,

a conductive additive and

a polymer being able to gel in the electrolyte salt solution

an anode substance, which contains as components

an active anode material being able to intercalate lithium,

an electrolyte salt solution and

a polymer being able to gel in the electrolyte salt solution

and a polymer gel electrolyte substance, which contains as components

an electrolyte salt solution and

a polymer being able to gel in the electrolyte salt solution,

where the cathode-, the anode- and the polymer electrolyte substance are prepared by mixing of the components, followed by

joining the layers of the anode-, the polymer gel electrolyte- and the cathode substance to each other and

laminating the layers onto current collector foils

The invention furthermore relates to rechargeable lithium polymer battery characterized by being composed of

a current collector foil

a cathode substance which contains a transition metal oxide as active cathode intercalation material, a conductive additive and a polymer gelled in the electrolyte salt solution

a polymer gel electrolyte substance consisting of a polymer gelled in the electrolyte salt solution

a anode substance which contains a intercalation material and a polymer gelled in the electrolyte salt solution

a current collector foil

Conventional lithium iron batteries are characterized by electrodes prepared by involving process solvents. The ionic conductivity is achieved by filling cavities with electrolyte solution; the cavities originate from the evaporation of the process solvents. The anode and cathode are electronically insulated by a porous separator film consisting of a polymer not being able to gel in the electrolyte.

Electrodes prepared according the Bell communications research Inc. method contain electrodes, which are prepared involving process solvents. As separators polymers are applied which first are mixed with the plasticizier and after dissolving of the plasticizer porosity is achieved which later is filled by electrolyte salt solution.

According to the actual invention, polymers able to gel in the electrolyte salt solution are applied for the polymer electrolyte and the electrode substances. For the three battery components the same or different polymers can be applied.

The gelling properties of the polymer allow the introduction of electrolyte salt solutions into the polymer. Generally the mass ratio of polymer to electrolyte salt is 10-90 to 90-10 preferable 30-85 to 70-15, most preferable 50-80 and 50-20. Above this ratio the ionic conductivity of the polymer electrolyte at room temperature is too low (i.e. less than 1 mS/cm) and the battery has a insufficient performance. Below this ratio the mechanical stability of the polymer electrolyte, especially in the separator, is insufficient.

There is no limitation about the type of polymer as long as the gelling properties of the polymer in the electrolyte salt solution are sustained. The choice of polymer depends on further requirements, being for example a sufficient adhesion of electrode substances on the current collector foil or the adhesion of the components on to each other. So instead of polymers or copolymers (for example polyvinylpyrrolidon-co-vinylacetate) also polymer blends can be used. Appropriate examples are polyvinylidenfluorite (PVDF) wilth polyacrylnitril (PAN) or polyvinylidenfluorite-hexafluorpropylene (PVDF-HFP) with polymethylmethacrylat (PMMA). Fluor containing homopolymers, copolymers or polymer blends are practically applied. Examples are polyvinylidenfluorite (PVDF), copolymers of vinylidenfluorite and hexafluorpropylene (VDF-HFP copolymer, trade under the name Kynar 2801), polymer blends of VDF-HFP-copolymers and Polyacrynitrile (PAN), for exampel in a ratio 85:15 and polymer belns of VDF-HFP-copolymers and polymethylmethacrylat (PMMA). The latter are suitable due to excellent adhesion properties. Preferred is a polymer blend of 40-95% w/w PVDF-HFP and 60-5% w/w PMMA, especially preferred is a ratio of 60-85% w/w PVF-HFP and 40-15% w/w PMMA.

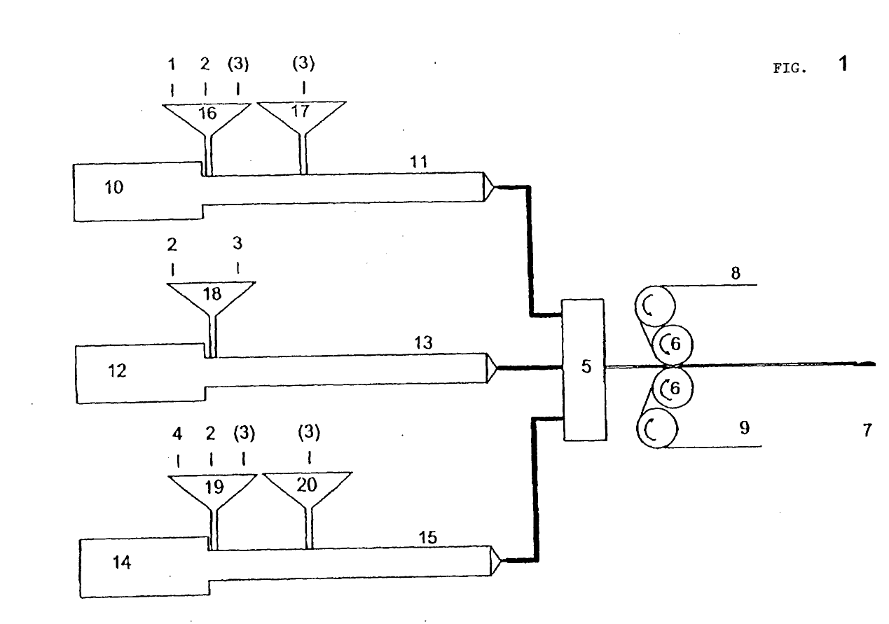

According the actual invention the electrode substances are processed in a temperature region where they can be thermoplastic deformed. The exact choice of temperature region depends on the choice of polymer. Conventional heated mixing equipment as kneaders and extruders can be used to processing and blend the three battery components. Preferable are extruders because they allow a continues process. The mixing equipment usually have an input, a mixing and an output zone which can be heated separately. Depending on the location where the starting materials are added, the mixing occurs in the first or a later inlet zone, or it occurs later in the mixing zone. Generally, thermoplastic properties are achieved at temperatures of 90-165° C. The preferred temperature varies with the type of gelled polymer and electrolyte salt. Preferable, to avoid an evaporation of the electrolyte solvent, in the mixing zone and output zone temperatures of 100-150° C. and 95-110° C. are applied, respectively. The electrode substances are extracted from the mixing equipment by use of a nozzle. Several choices of further processing exist: One possibility is to extract the electrode films separately onto current collector foils, and to extract the polymer gel electrolyte film onto a substrate foil. Then, during winding the electrode films, attached to the metal foils are brought together with the polymer gel electrolyte. Preferred is however another possibility, the use of a co-extrusion nozzle as shown in FIG. 1. Here the electrode films immediately are attached to the polymer gel electrolyte film. Current collector foils are then laminated onto the electrode/polymer/electrode compound.

The gel polymers used in the three components do not necessarily need to be similar. In some cases it is preferable to modify the composition to achieve an improved adhesion between electrode and current collector. The electrolyte salt used in the three components, however, should be the same to avoid diffusion processes disturbing the electrochemical processes during operation.

Suitable electrolyte solvents are ethylene carbonate (EC), propylene carbonate (PC) Dimethyl carbonate (DMC), diethyle carbonate (DEC), N-Methylpyrrolidon (NMP) or gamma-butyrolacton (GBL), or mixtures thereof.

Suitable electrolyte salts are lithium salts as LiClO₄, LiPF₆, LiBF₄, LiCF₃SO₃. LiCl₄ is preferred by economical reasons.

Further details regarding suitable electrolyte solvents and electrolyte salts are described in the textbook “Lithium batteries—New materials, developments and perspectives”, ed. By G. Pistoia, Industrial Chemistry Library Vol. 5. Elsevier Science, Amsterdam 1994.

As anode intercalation material hard carbon, natural or synthetic graphite or mixtures thereof can be used. Intercalation graphite is preferred.

To achieve all improved electrochemical properties of the anode substance the concentration of electrolyte salt is optimized for the particularly intercalation graphite. Preferable 20-250 mg of electrolyte salt solution are applied per sqm of intercalation graphite.

The cathode materials, able to intercalate lithium, are transition metal oxides like LiCoO₂, LiNiO₂ or LiMn₂O₄. The lithium manganese spinel is preferred due to low cost and due to good ecological properties. Further details about intercalation cathodes basing on transition metal oxide are described in the textbook “Lithium batteries—New materials, developments and perspectives”, ed. By G. Pistoia, Industrial Chemistry Library Vol. 5, Elsevier Science, Amsterdam 1994.

As conductive additive preferable carbon black is applied, the products are commercially available.

The advantages of the actual invention are to prepare the components of a lithium polymer battery (i.e. the electrodes (anode and cathode) and the polymer gel electrolyte) without applying a process solvent. Not only ecological harm solvents as dimethyl formamid, dimethyl acetamid, N-methyl pyrrolidon or tetrahydrofuran are avoided, but also the cost of processing is significantly lower. Furthermore, the high cost of equipment for recycling and purification of the solvents is avoided. Another significant advantage of the actual invention is that standard equipment used in the plastic industry like extruders or kneaders can be applied to prepare the lithium polymer batteries.

In the following the invention is in further detail described by use of figures.

FIG. 1) The process of this invention, schematically

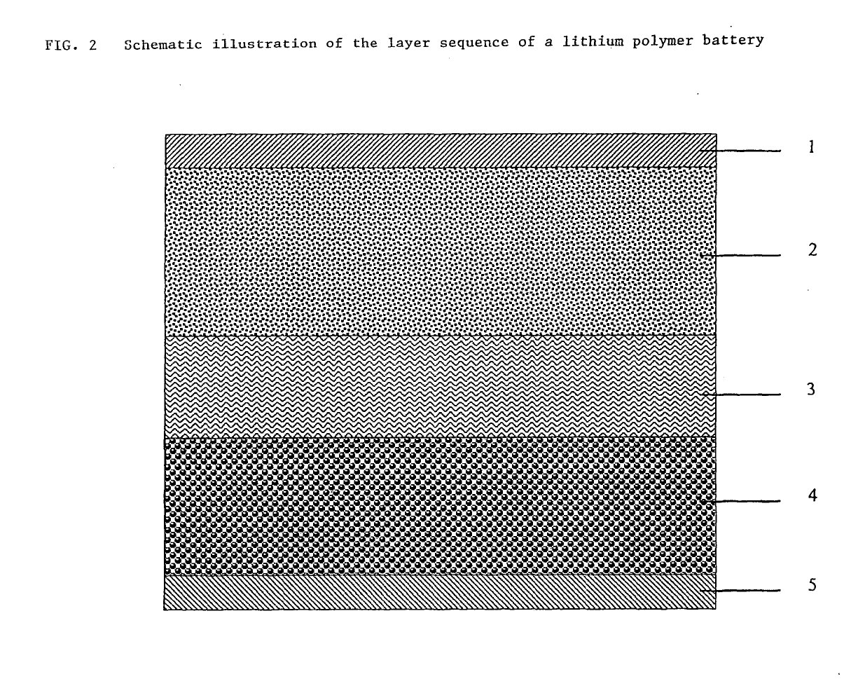

FIG. 2) A lithium polymer battery, prepared by the method of this invention, schematically

In FIG. 1 the numbers have the following meaning:

1 Intercalation graphite

2 Electrolyte salt solution

3 Polymer

4 Transition metal oxide and conductive additive

5 Extrusion nozzle

6 Laminating roller

7 Lithium polymer cell

8 Current collectors

9 Current collectors

10 Mixer for anode substances

11 Anode substance

12 Mixer for the polymer gel electrolyte

13 Polymer gel electrolyte

14 Mixer for cathode substance

15 Cathode substance

16 1^{st} input zone for anode substance

17 2. Input zone for cathode substance

18 1^{st} input zone for the polymer gel electrolyte

19 1^{st} input zone for the cathode substance

20 2^{nd} input zone for the cathode substance

The mixing of the electrode substances for the single components occurs in continuesly operating equipment known from the plastic industry.

The anode substance (11) is prepared by the simultaneous addition of electrolyte salt solution (2) and of the intercalation graphite (1) in the 1^{st} input zone (16) of the continuously operating mixer for the anode substance (10). The polymers (3) can partly, or completely be added in the 1^{st} (16) or 2^{nd} (17) input zone. In the latter case the starting materials, added in the 1^{st} zone (19) are already premixed when the polymer is added.

The polymer gel electrolyte (13) is prepared by a simultaneous addition of electrolyte salt solution (2) and polymer (3) in the 1^{st} input zone (18) of the continuously operating mixer for the polymer gel electrolyte (12). The electrolyte salt solution (2) for the polymer gel electrolyte (13) is the same as the solution used for the anode (11) and cathode (15) substance. As polymers for example blends of PVDF-HFP and PMMA can be applied, the ratio in the electrode substance can differ from the ratio in the polymer gel electrolyte (13).

The cathode substance (15) is prepared by a simultaneous addition of the electrolyte salt solution (2), of a mixture of lithium manganese spinel (intercalation cathode) and of the conductive additive (4) in the 1^{st} input zone (19) of the continuously operating mixer for the cathode substance (14). The polymers (3) can partly, or completely, be added in the 1^{st} (19) or 2^{nd} (20) input zone, in the latter case the starting materials. In the 1^{st} zone (19) are already premixed when the polymer is added.

The extrusion nozzle (5) forms the battery components anode substance (11), polymer gel electrolyte (13) and cathode substance (15) to a suitable thickness and width. The next process step is the laminating with help of laminating rollers (6) where the layers formed by the extrusion nozzle are (5) laminated onto the current collector foils (8,9). The current collector foils are copper foil or mesh (8) or aluminum foil or mesh (9). After that the lithium polymer cell is winded.

In FIG. 2 the numbers have the following meaning:

Current collector (aluminium foil)

2 Positive electrode with

transition metal oxide (Li—Mn-spinel)

conductive additive (carbon black)

in electrolyte salt solution gelled polymer

3 Polymer gel electrolyte

4 Negative electrode with

intercalation graphite

in electrolyte salt solution gelled polymer

5 Current collector foil (copper foil)

In the following examples are given to describe the invention

### EXAMPLE 1

Example 1 shows the preparation of the components i.e the electrode substances and the polymer gel electrolyte by continuously operating blenders of similar construction. The composition of the polymer gel electrolyte is listed below. For all three components the continuously operating blender “contera” (IKA) is used. The had a gear pump and an extrusion nozzle, which can be separately heated. The trade name “Kynar” 2801 is a VDH-HFP copolymer and the trade name Plex 6770 is PMMA.

| Anode | % w/w | electrolyte | % w/w | cathode | % w/w |
|---|---|---|---|---|---|
| Graphite | 53 | | | LiMn₂O₄ | 65 |
| | | | | carbon black | 4 |
| Kynar 2810 | 6.5 | Kynar 2801 | 21 | Kynar 2801 | 6.5 |
| Plex6770 | 10 | Plex 6770 | 14 | Plex 6770 | 6 |
| LiClO₄ | 2.5 | LiClO₄ | 5.4 | LiClO₄ | 1.5 |
| EC | 14 | EC | 29.8 | EC | 8.5 |
| gamma GBL | 14 | gamma GBL | 29.8 | gamma GBL | 8.5 |

The anode substance is prepared by a simultaneous addition of electrolyte salt solution (2), intercalation graphite (1) and of the polymer mixture (3) in the input zone (16) of the continuously operating kneader (10).

The polymer gel electrolyte is prepared by a simultaneous addition of electrolyte salt solution (2) and of the polymers (3) in the input zone (18) of the continuously operating kneader (12).

The cathode substance is prepared by a simultaneous addition of electrolyte salt solution (2), of a mixture of Li—Mn-spinel and conductive additive (4) and of the polymers (3) in the input zone (19) of the continuously operating kneader (14).

The gear pumps transport the electrode substances and the polymer gel electrolyte to the extrusion nozzle and then to the current collectors (8,9). Then the lamination by applying of rollers, and finally the winding of the electrochemical cell follows.

### EXAMPLE 2

The electrode substances with the same composition as disclosed in example 1 are prepared by continuesly operating co-kneaders (BUSS). A two-shaft-extruder (Collin) is used to prepare the polymer gel electrolyte.

The anode substance is prepared by a simultaneous addition of electrolyte salt solution (2), intercalation graphite (1) and of the polymers (3) into the input zone (1) of the BUSS kneader (10).

The polymer gel electrolyte is prepared by a simultaneous addition of electrolyte salt solution (2), intercalation graphite (1) and of the polymers (3) into the input zone (18) of the two-shaft-extruder (12).

The cathode substance is prepared by a simultaneous addition of electrolyte salt solution (2), of a mixture of lithium manganese spinel and conductive additive (4) and of PMMA (3) into the input zone (19) of the BUSS co-kneader (14). The PVDF-HFP (3) is added in the input zone (20) at a location where the components inserted into the input zone (19) are already premixed.

Then in the same way as in example 1 the electrochemical cell is winded.

Examples 1 and 2 describe the preparation of lithium polymer cells. The winded cells are electrically contacted at the front of the coil, put into stainless steel casing, closed and-welded. Electrochemical testing was performed with a Digatron-charger. The cells were galvanostatically charged to 4.3 V by applying a constant current of 0.15 mA/cm², then the charging was continues by a potentiometric charge at 4.3 V for 2 hours. The cells were discharged by a current of 0.15 mA/cm² until the lower cut-off voltage of 3.5 V is reached.

The cell of example 1 has a nominal capacity of 15 Ah, and electrode area of 0.75 m², the electrode has a width of 15 cm and the diameter of the cell is 4.7 cm. Th edischarge capacity was 14.4 Ah, corresponding to 96% of the nominal capacity.

The cell of example 2 has a nominal capacity of 30 Ah, and electrode area of 1.5 m², the electrode has a width of 15 cm and the diameter of the cell is 6.6 cm. The discharge capacity was 29.2 Ah, corresponding to 97% of the nominal capacity.

1. A solvent free process to supply rechargeable lithium polymer batteries, the process being characterized by a separate preparation of
a cathode substance, which contains components
an active cathode materials being a transitional metal oxide able to intercalate lithium,
an electrolyte salt solution,
a conductive additive and
a polymer being able to gel in the electrolyte salt solution
an anode substance, which contains as components
an active anode material being able to intercalate lithium,
an electrolyte salt solution and
a polymer being able to gel in the electrolyte salt solution
and a polymer gel electrolyte substance, which contains as components
an electrolyte salt solution and
a polymer being able to gel in the electrolyte salt solution,
where the cathode-, the anode- and the polymer electrolyte substance are prepared by mixing of the components, followed by
joining the layers of the anode-, the polymer gel electrolyte- and the cathode substance to each other and
laminating the layers onto current collector foils

2. The process according claim 1 further characterized by a polymer gel electrolyte consisting of 20-60% by weight are polymer and 80-40% by weight are electrolyte salt solution.

3. Process according claim 1 or 2 further characterized by cathode, anode and polymer gel electrolyte containing the same polymer.

4. Process according one of the claims 1-3 further characterized by a polymer gel electrolyte consisting of a mixture of 40-95% by weight poly[vinylidendifluorid-hiexaflouropropylen] (PVDF-HFP) and 60-5% by weight by weight polymethyl methacrylate (pmma).

5. Process according claim 4, further characterized by a polymer mixture containing 60-85% by weight PVF-HFP and 40-15% by weight PMMA.

6. Process according one of the claims 1-5 further characterized by an electrolyte salt solution containing ethylene carbonate, propylene carbonate, dimethyl carbonate, diethyl carbonate, N-Methylpyrrolidon or Gamma-butylolacton or a binary or a ternary mixture thereof as solvent.

7. Process according one of the claims 1-6 further characterized by a electrolyte salt being a lithium salt chosen from one ore more of LiClO₄ , LiPF₆, LiCF₃SO₃.

8. Process according one of the claims 1-7 further characterized by the application of an anode intercalation material being natural or synthetic graphite, or mixtures whereof.

9. Process according one of the clams 1-7 further characterized by the application of an cathode intercalation material being LiCoO₂, LiNiO₂ or LiMn₂O₄.

10. Rechargeable lithium polymer battery characterized by being composed of
a current collector foil
a cathode substance which contains a transition metal oxide as active cathode intercalation material, a conductive additive and a polymer gelled in the electrolyte salt solution
a polymer gel electrolyte substance consisting of a polymer gelled in the electrolyte salt solution
a anode substance which contains a intercalation material and a polymer gelled in the electrolyte salt solution
a current collector foil

11. Lithium polymer battery according claim 10, further characterized by one or more characteristics is defined in at least one of the claims 1-9.
